(19) United States
(12) Patent Application Publication
(10) Pub. No.: US 2007/0189923 A1
(43) Pub. Date: Aug. 16, 2007

(54) Device for chemical analysis of sample components

(76) Inventors: Markus Lenhard, Viersen (DE); Ulrich Lundgreen, Gutersloh (DE); Aria Farjam, Vaals (NL)

Correspondence Address: FRIEDRICH KUEFFNER, 317 MADISON AVENUE, SUITE 910, NEW YORK, NY, 10017, US

(21) Appl. No.: 11/704,706

(22) Filed: Feb. 9, 2007

(30) Foreign Application Priority Data
Feb. 9, 2006 (EP) 06 101 432.0-2214

(51) Int. Cl. B01L 3/00

(52) U.S. Cl. 422/61

(57) ABSTRACT

A test kit for the chemical analysis of sample components which are gaseous or convertible into the gas form. The test that has at least two separate regions, of which the first serves for receiving the sample and the second serves for receiving the gases liberated from the sample. The second region containing a gas-sensitive reagent which experiences a change due to contact with the gas generated in the first region; the two regions being separated from one another by a separation element having a mean pore diameter of 0.5 μm to 1000 μm (frit).

### BACKGROUND OF THE INVENTION

1. Field of the Invention

The present invention relates to a novel test kit for the chemical analysis of sample components which are gaseous or convertible into the gas form.

2. Description of the Related Art

In analytical chemistry, the methods which are of particular importance are those in which the parameters to be determined are separated off selectively from the sample mixture by conversion into the gas form. In this case, after conversion to the gas phase, direct determination can be carried out by means of gas chromatography, atomic absorption or IR and chemoluminescence spectrometry. In addition, there is also the possibility of indirect determination using the methods of conductometry, coulometry, potentiometry, gas volumetric methods, acidimetric mass analysis, manometric measurement, iodometric mass analysis and photometry.

U.S. Pat. No. 5,320,807 describes a test kit using which the state and course of the process can be monitored in composting facilities. For this purpose, a sample of the compost is brought into a closed vessel and allowed to rest there for a period of a few hours. During this period an equilibrium is established in gas form of the container which is determined by escape of CO₂ and volatile organic acids from the compost. Using one or more detection reagents which are suspended in the gas space of the container it is then possible to detect and measure the concentration of CO₂ or the volatile organic acids by optical change of the reagents. The entire kit is only used for the examination of compost samples. A disadvantage of it is that no quantitative measurements are permitted and, to fill it, not only the sample space but also the detection space must be open.

U.S. Pat. No. 4,315,890 describes a device by which volatile sample constituents, in particular from body fluids, are to be determined. There is thus no generation of gases, only the expulsion of gases which are present. The detection of the expelled gases proceeds in a closed vessel by reaction with or absorption to special gas-sensitive detection reagents arranged spatially separated. The device consists of two glass tubes which can be pushed one inside the other (in the manner of a syringe). Also in this case it is a disadvantage that the device must be entirely open during filling. There must also be a connection to the exterior in order to be able to push the vessel parts into one another and to equalize the volume displaced.

WO 02/090975 A2 discloses a method for the fluorimetric or photometric determination of substances which are gaseous or convertible into the gas form in samples. In a cuvette having one or more ion-permeable, gas-permeable, in particular silicone and/or Teflon membranes, digestion reactions, optional purification steps and the detections can be carried out.

In addition, EP1146335B1 discloses a test kit for the analysis of sample components which are gaseous or convertible into the gas form having a sample reception vessel for receiving the sample via a vessel orifice and having an analytical vessel for receiving the component to be analysed via a vessel orifice, the analysis vessel containing an indicator reagent or being able to be furnished with an indicator reagent and being usable as a measuring base in an optical measuring instrument. The test kit is furnished with an adapter via which the vessel orifices can be connected to one another. The analytical vessel contains a pressure relief device. In the vessel a separation membrane made of a hydrophobic material is arranged. Nothing in more detail is set forth in this application on the type of the material.

EP0663239 B1 discloses a test kit which is used for the chemical analysis of sample substances which are gaseous or convertible into the gas form. This comprises two separate vessels of which one serves for receiving the sample and a second serves for receiving the gases liberated from the sample. The second vessel contains a gas-sensitive reagent which undergoes an optical change by contact with the gas generated in the first vessel. It is designed such that it can be inserted into an optical measuring instrument as a measuring base. The vessels can be connected to one another via an adapter. The adapter is furnished with a semipermeable membrane which is permeable only to gases. As membrane material, hydrophobic substances come into consideration.

WO 00/75653 A2 describes an analytical device which consists of two vessels which can be fitted one inside the other. In this case the inner vessel contains the indicator. The sample to be analysed is situated in the outer vessel. Both vessels are connected to one another only via the gas space. Heating liberates the volatile substances from the sample into the gas phase where they come into contact with the indicator via the gas space and produce a change therein. The change of the indicator is determined by means of transmission of a light beam.

EP 1605260 A2 further discloses a method for determining the organically bound carbon in a device which has at least one reaction region and one detection region. In this case the sample is placed into the reaction region of the device, the inorganic carbon is expelled, wherein to expel the carbon dioxide formed by conversion of the inorganic carbon, the reaction region is agitated, the device is sealed, by means of physical, chemical, biochemical or microbiological methods the organically bound carbon is converted to gaseous carbon dioxide, the gaseous carbon dioxide is transferred to the detection vessel and on the basis of the colour changes of the indicator, the carbon dioxide content is determined by methods known per se.

Methods and devices for determining the organically bound carbon are in addition disclosed by DE 19616760 A1, WO 99/42824 A1, DE 10018784 C2, DE 10121999 A1, DE 2534620 A1.

To determine the inorganically bound carbon, it is frequently necessary to remove the inorganic carbon. For instance, DE 19906151 A1, DE 19616760 A1, DE 4307814 A1, DE 10018784 C2, DE 1012199 A1, EP 0663239 B1 and WO 00/75653, for example, state that the inorganic carbon compounds can also be removed by acidification and subsequent expulsion.

The test kits described, which have existed for some years, consequently have the following typical operating procedure when carrying out analyses:
1. the inorganic carbon of the sample is converted, after acidification, into carbon dioxide and expelled,
2. the sample depleted by the inorganic carbon is placed in the reaction region of the test kit,
3. a chemical oxidizing agent is added,
4. the reaction region is connected via the gas space to an indicator solution which contains a colour reagent sensitive to carbon dioxide,
5. the reaction region is heated, the chemically bound organic carbon being converted by the oxidizing agent to carbon dioxide and this gas is transferred to the indicator solution,
6. the reaction region is cooled,
7. the colour change of the indicator solution due to the carbon dioxide driven across is measured in a photometer as extinction and the TOC is calculated from the extinction by means of available calibration data,
8. the reaction regions used together with the consumed reagents are returned to the test kit packaging and sent back to the supplier later for proper disposal.

In summary it may be stated that according to the prior art described, a separation of reaction region and analysis region is provided. Generally, gaseous analytes are transferred to an indicator liquid and there measured photometrically.

The reaction region and analysis region are separated by means of membranes. For instance, in WO 02/090975 A2, use is made, for example, of silicone membranes, in EP1146335 A2 and EP0663239 B1, use is made of Teflon membranes. In WO 00/75653 A2, a shared gas space is provided for separation of the vessels.

The membranes used hitherto are accompanied by various disadvantages:

Teflon membranes require a support fabric. Production and handling are therefore complex. These are multipart elements which consist of a plurality of combined individual parts.

Although the silicone membranes are one piece, they are complex in handling. For instance, the insertion into the cuvette is associated with complications. That is assembly is associated with considerable complexity.

The system provided in WO 00/75653 A2 is less complex in production. However, there can be difficulties in handling. Since it is an open system, there can also be uncertainties in handling and analysis.

### SUMMARY OF THE INVENTION

It is the primary object of the present invention to provide, instead of the hydrophobic membranes customary in the prior art, a material which is less technologically complex. An inexpensively produced separation element is to be provided.

In accordance with the present invention, this object is achieved by a test kit for the chemical analysis of sample materials which are gaseous or convertible into the gas form having at least two separate regions, of which the first serves for receiving the sample and the other for receiving the gases liberated from the sample, the second region containing a gas-sensitive reagent which experiences a preferably optical change due to contact with the gas generated in the first region, and the two regions being separated from one another by a separation element having a mean pore diameter of 0.5-1000 μm (frit).

According to the invention, macroporous separation elements are used. Their mean pore diameter is generally greater than 0.5 μm. Preference according to the invention is given to pore diameters of 0.5 to 500 μm, particular preference from 0.5 to 100 μm, very particular preference from 2 to 50 μm.

In accordance with a preferred embodiment according to the invention, the separation element has a thickness (material thickness) of greater than 1 mm, preferably up to 20 mm. Particular preference is given to 1 to 10 mm, very particular preference to 2 to 5 mm. The expression “thickness” is to be understood as material thickness. That is, provided the separation element is a disc, it is in principle the height of the cylinder. The same applies when the separation element is, for example, in the shape of a cone or parallepiped. If the separation element is constructed in the form of a sphere, the expression “thickness” or “material thickness” is taken to mean the diameter thereof.

The separation element described is termed hereinafter a frit. Frit is accordingly to be understood as meaning separation elements:
1. one-piece separation element,
2. macroporous structure, the pore diameter preferably being greater than 0.5 μm,
3. preferably thickness greater than 1 mm, particularly preferably less than 20 mm,
4. it is not a membrane. This is because such membranes have an extremely low thickness, are film-like and are frequently produced as what is termed “thin skin”, or they are flexible or not self-supporting alone.

In a preferred embodiment the separation elements contain or are sintered materials. In a preferred case, they are simple filters made of porous sintered material. They are produced in a simple sinter method from fine powders. The particle size of the powder determines the later pore width of the frit. Preference is given to particle sizes of 0.5 to 500 μm, particular preference to 2 to 50 μm.

In a further embodiment, the separation elements contain sponges, foamed materials or else hydrophobic or hydrophilic variants. Hydrophobic variants are preferred. Fabrics, for example textile fabrics, cellulose fabrics, felt fabrics, glass fibre fabrics or metal fabrics, may also be contemplated.

Foams or foamed materials in the meaning of the invention are structures of gas-filled, bead-shaped or polyhedra-shaped cells which are bordered by liquid, semi-liquid, high-viscosity or solid cell ridges. The cell ridges, linked via what are termed node points, form a coherent framework. Foam lamellae stretch between the cell ridges to form what are termed closed-cell foam lamellae. If the foam lamellae are destroyed or at the end of foam formation they flow back into the cell ridges, an open-cell foam is obtained.

Accordingly, for the separation element, open- or closed-pore foams or open- and closed-cell foams, foamed materials or sponges in the above-described sense may be used according to the invention.

In summary it must be stated that in principle all sponge-like structures may be used which lead to the described conditions. Accordingly, not only naturally occurring sponges but also synthetically produced products are suitable for the purposes of the invention.

A further example of the separation elements usable according to the invention is “controlled pore glass” (CPG). This is taken to mean what is termed porous glass. Such materials are known as support materials for gel chromatography and gas chromatography. They contain in principle an SiO₂ backbone and also B₂O₃. The glasses can be produced, for example, from high sodium borate glass by inducing separation by heating and subsequently extracting the borate phase by cleaning agents.

The methods for producing the said embodiments for use in the separation elements according to the invention are widely known. This applies, for example, to the sintering methods. A further example for the production of porous elements is leaching.

Leaching is the extraction of a substance from solid mixtures by suitable solvents, for example with water. One example of the extraction is boiling. Likewise, extraction using bacteria (bioleaching) is possible. Such methods are known in hydrometallurgy for treatment and disintegration of ores and from oil recovery from oil sands and shales.

The frits according to the invention can be produced from various materials. Those which are familiar are plastic, metal or glass. It is surprising that using these frits the separation of gas and liquid is achievable in a simple manner. In the final result, the use of the described frits leads to significant cost savings.

In addition, it is surprising according to the invention that non-hydrophobic starting material (for example metal) can also be used and the resultant frits are usable for the separation.

By variation of the starting material, additional functionalities can be integrated into the frits. For instance, by incorporation additional reactants, for example interfering impurities can be removed from the analysis gas. For example, a chlorine absorber can be incorporated. As absorber material, use can be made, for example, of metal powder. The use of metal or metal-containing frits for the TOC test has the advantage that interfering chlorine gas which is formed by oxidation of the sample reacts with the metal of the frits. As a result the indicator solution is protected from the chlorine. The frit thus simultaneously achieves two objects, that is the separation of CO₂ from the aqueous sample, and also the retention of interfering gas, for example chlorine gas. Further service examples of the use of various frits are analytical test kits in which a gaseous analyte is formed and is used for detection (for example tests for cyanide, organic acids, ammonium, arsenic, mercury, chlorine etc.).

The particular advantages of the separation element according to the invention (frit) are that it is inexpensive to produce and simple to handle. Also, modification of the material for example by addition of metal particles, can lead to additional functionalities. For example, in this case, reaction of the indicator with interfering chlorine gas can be prevented.

The described frits can accordingly be constructed in various shapes according to the desired function. Apart from this, in the test kit according to the invention, a plurality of frits can also be used at the same time.

Also, various functionalities can be combined with one another by different frits. In a further embodiment, the frit can also have a closing mechanism. That is the system can be separated gas-tightly into a reaction region and sample reception region and as required the frit can be opened or closed for a passage of gas.

In a variant according to the invention, the test kit comprises two separate individual vessels of which the first serves for reception of the sample and the second for reception of the gases liberated from the sample. The gas-sensitive reagent is present here in the second vessel. The second vessel is at the same time equipped in such a manner that it can be inserted into an optical measuring instrument as measurement support in which the optical change of the indicator reagent can be measured.

The vessels of the test kits can preferably be coupled to one another by means of an adapter. Coupling via the adapter connects the two vessels. In addition, it simultaneously gas-tightly closes them from the outer space, that is it is designed such that no leaks occur in the adapter region. This is intended to prevent gases entering from the outside or gases exiting from them falsifying the analytical result, consequently complete gas transfer without interfering effects proceeds.

The adapter can be constructed in such a manner that it contains the above-described frits according to the invention.

The test kit in this embodiment thus forms a closable container (formed from two vessels and the adapter), in which a reaction zone is arranged within a spatially-delimited region and which serves for reception of a sample and for gas generation from this sample and in which in a further delimited region a detection zone is arranged having a gas-sensitive reagent which serves for detection of the gases generated in the reaction zone, the reaction zone being connected chemically to the detection zone only via the gas space.

The use of the test kit with the adapter and the integrated separation element can appear such that first the vessel with the detection zone, which, for storage stability, is provided with a suitable closure, and contains a prepackaged indicator solution or another suitable detection reagent, is opened, and instead of the closure the adapter with the integrated separation element is screwed on. Likewise, the second vessel which contains the reaction zone is opened. It can also contain substances required for the analysis in prepackaged form. Subsequently, the sample to be analysed is placed into the vessel having the reaction zone and both vessels are connected to one another gas-tightly against the outer space using the adapter. If appropriate, the vessel having the reaction zone is suitable for being treated, for example by heating, in order to promote the generation and liberation of the gases to be detected, and to accelerate gas transfer into the detection zone. After liberation of the gases and their reaction with the detection reagent in the detection zone, the changes thus generated are detected by suitable measurement methods.

For the solid or liquid gas-sensitive reagent, use can be made of, for example, an optically sensitive solid-phase detection layer, preferably an optode membrane, which is arranged in the detection zone. Optode membranes are polymer-based film-like layers which react to a chemical influence, for example due to the gases to be analysed, by a change in their optical behaviour, for example a colour change. Such optode membranes in this case consisting of plasticized ethyl cellulose and an incorporated pH indicator having a selective response to carbon dioxide have been described, for example, by A. Mills and co-workers in Anal. Chem. 1992, 64, 1383-1389. Optode membranes based on plasticized PVC and an incorporated lipophilic benzaldehyde derivative developed by M. Kuratli and co-workers (Anal. Chem. 1993, 65, 3473-3479) react in a similar manner with a change in their UV absorption (λₘₐₓ=256 nm) as soon as they are brought into contact with sulphur dioxide.

Assuming suitable design of the container, the gas-sensitive reagent can also be a liquid which preferably contains a dissolved indicator or a colour reagent. Preferably, aqueous systems come into consideration. A precondition for their usability is that the surface tension is such that it ensures that the indicator liquid, when the test kit is used in practice, does not pass through the pores having the abovementioned sizes. Likewise, accordingly, non-aqueous systems are also usable provided that they have the required surface tensions and at the same time they do not pass through the pore sizes according to the invention with proper use of the test kit.

For integration of the device according to the invention into an analytical system conventional on the market it is designed in such a manner that it can be inserted into an optical measuring instrument as a measuring base. In this case it can be, in particular, designed as a cuvette for a photometer.

In combination with all the abovementioned variants of the test kit according to the invention, for special applications it can be modified in such a manner that, in at least a partial region (reaction zone or detection zone) it is suitably spatially subdivided so that in this partial region samples, reagents or phases initially kept separately from one another can be mixed or brought into contact with one another only by simple mechanical manipulations, such as, for example tipping, inverting or swirling the device, without it being necessary to open the device.

The test kit of the invention is preferably employed in a method for chemical analysis of sample components which are gaseous or convertible into the gas form in a device of the above-described type. In this method the sample to be analysed is placed in the reaction zone of the container. After this the sample constituents which are gaseous or gaseous expellable are transferred to the detection zone where, by reaction with the solid or liquid reagent, they cause it to change, which is evaluated by known measuring methods. Preferably, these are optical changes and measuring methods.

To generate the gaseous components from the sample, use can be made of physical, chemical, biochemical or microbiological methods. Chemical methods which may be mentioned are preferably acidification, alkalization, oxidation, reduction and derivatization.

According to the invention, preferably suitable technical measures ensure that the differential pressure between the indicator region and the reaction region is small.

The transfer of the gaseous constituents from the vessel having the reaction zone to the vessel having the detection zone, however, can also be accelerated by generating a higher gas pressure in the first vessel or by generating a reduced pressure in the second vessel, so that over the shared gas space pressure equilibration and thus gas transport from the reaction zone to the detection zone proceeds. A higher gas pressure can be generated, for example, by a chemical reaction in which a carrier gas is formed. A reduced gas pressure can be effected, for example, by consumption of a gas (that is by its absorption) in the detection zone. Likewise, the installation of customary pressure-relief devices is possible. Examples are valve constructions. The membrane which can be pierced by means of a cannula which is provided in EP1146335 B1 can also be used here. Generation and transfer of the gaseous sample constituents can also proceed via energy supply to the reaction zone and/or by chemical or physical reactions. Suitable means of energy supply which come into consideration are, inter alia, heating, irradiation, in particular with ultraviolet or microwaves, ultrasound treatment or an electrical current flowing through the reaction zone.

In addition it is possible to achieve the conversion to gaseous compounds by using biological or biochemical methods. That is by using enzymes, microorganisms or plant or animal cells, likewise reduction or oxidation can be achieved in order to generate gaseous compounds.

After transfer of the analyte gas to the detection zone, if appropriate it can be advantageous that the gas to be detected is first only adsorbed there and the optical change does not proceed until after addition of a further reagent. This is expedient, for example, when the temperature stress owing to the heating of the reaction zone required for transfer of the gaseous constituents is too high for one or more of the indicator components active in the detection zone.

In the case of special applications, for example, when after mixing sample and reagent, spontaneous gas liberation proceeds such that gas losses would be expected if after acidification. For determining the TC, this conversion is achieved by oxidation.

A preferred evaluation method for the optical changes in the detection zone is photometry. In addition, with regard to test kits conventional on the market, it is expedient, to carry out the analysis, to prepackage required reagents in the form of complete tests and to accommodate them in storable form in the individual closed vessels.

The test kit of the invention can be used, in particular, for the chemical determination of biological oxygen demand (BOD), of bound carbon (TC), of inorganically bound carbon (TIC), of organically bound carbon (TOC), of dissolved organic carbon (DOC), of volatile organically bound carbon (VOC), of particulate organically bound carbon (POC), of adsorbable organic halogen compounds (AOX), of bound organic halogen compounds (TOX), of particulate organic halogen compounds (POX), of dissolved organic halogen compounds (DOX), of extractable organic halogen compounds (EOX), of low-volatility halogenated hydrocarbons (SHKW), of highly volatile halogenated hydrocarbons (LHKW), of bound nitrogen, of cyanide, of sulphur, of phosphorus, of arsenic, of antimony, of mercury, of phenols and of other volatile organic compounds.

The various features of novelty which characterize the invention are pointed out with particularity in the claims annexed to and forming a part of the disclosure. For a better understanding of the invention, its operating advantages, specific objects attained by its use, reference should be had to the descriptive matter in which there are illustrated and described preferred embodiments of the invention.

### BRIEF DESCRIPTION OF THE DRAWING

In the drawings:

FIG. 1 is a sectional view of a device according to the present invention; and

FIG. 2 is a schematic view of another embodiment of the device according to the present invention.

### DETAILED DESCRIPTION OF THE INVENTION

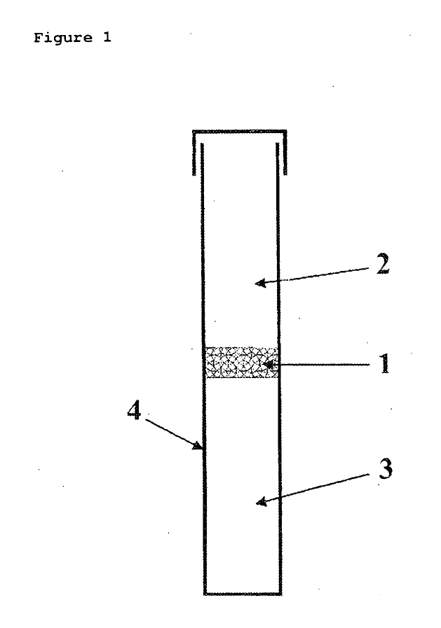

FIG. 1 shows a device which essentially consists of a closable vessel;

This is separated by a frit 1 into two regions, the reaction region 2 and the detection region 3.

The reaction region 2 serves for reception of the sample and gas generation.

The detection region 3 contains the indicator which by absorption and chemical reaction of the gases generated in the vessel 4 experiences a change (for example colour change) which can be evaluated by means of suitable known measurement methods such as photometry, fluorimetry, luminometry, refractometry, reflectometry and ATR photometry.

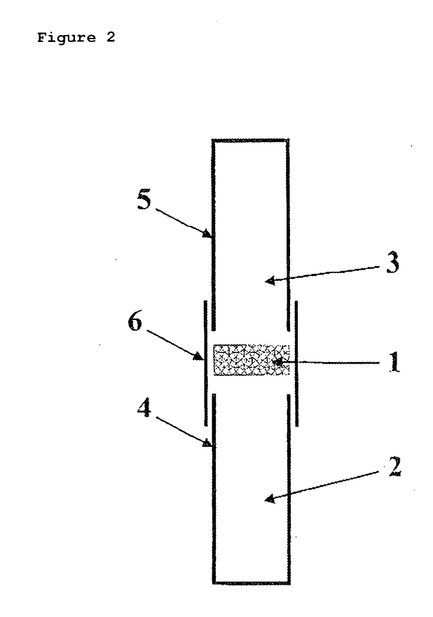

FIG. 2 shows an embodiment of the test kit of the invention in which reaction zone 2 and detection zone 3 of the closable container consist of two separate vessels 4, 5 which are connected to one another via the adapter 6. The adapter can contain the frit 1 of the invention or else a plurality of frits.

In the test kit, the vessel 4 contains the reaction zone 2 and therefore serves for receiving the sample and for gas generation from the same. The vessel 5 contains the detection zone 3.

While specific embodiments of the invention have been shown and described in detail to illustrate the inventive principles, it will be understood that the invention may be embodied otherwise without departing from such principles.

We claim:

1. A test kit for the chemical analysis of sample components which are gaseous or convertible into the gas form, the test for comprising:
a) at least two separate regions, of which the first serves for receiving the sample and the second serves for receiving the gases liberated from the sample,
b) the second region containing a gas-sensitive reagent which experiences a change wherein contacted by the gas generated in the first region, and
c) the two regions being separated from one another by a separation element having a mean pore diameter of 0.5 μm to 1000 μm (frit)

2. The test kit according to claim 1, wherein the thickness of the separation element is 1 mm to 20 mm.

3. The test kit according to claim 2, wherein the separation element consists of plastic, metal, glass, ceramic, activated carbon, cellulose or a mixture of one or more of these materials.

4. The test kit according to claim 1, wherein the separation element contains components which react with the water sample, the reagents and/or the gases.

5. The test kit according to claim 4, wherein the separation element contains metal particles as components.

6. The test kit according to claim 1, wherein the separation element consists of open-pore or closed-pore foam, foamed material or sponge.

7. The test kit according to claim 1, wherein the separation element is comprised of a disc, cone, parallelepiped, sphere.

8. The test kit according to claim 1, wherein the separation element contains additions which control the gas passage.

9. The test kit according to claim 1, wherein the separation element consists of material which reacts with the gases passing through in order to remove impurities of the gas.

10. The test kit according to claim 1, wherein the reaction regions are separate individual vessels.

11. The test kit according to claim 10, comprising an adapter for connecting the vessels to one another.

12. The test kit according to claim 11, wherein the separation element is arranged in the adapter.

13. A method for producing a test kit having the method comprising the separation element by sintering from plastic, metal, glass, ceramic, activated carbon or a mixture of one or more of these materials or further materials.

14. The method according to claim 13, wherein the separation element is produced by leaching.

15. The test kit according to claim 1 for the chemical determination of biological oxygen demand (BOD), of bound carbon (TC), of inorganically bound carbon (TIC), of organically bound carbon (TOC), of dissolved organic carbon (DOC), of volatile organically bound carbon (VOC), of particulate organically bound carbon (POC), of adsorbable organic halogen compounds (AOX), of bound organic halogen compounds (TOX), of particulate organic halogen compounds (POX), of dissolved organic halogen compounds (DOX), of extractable organic halogen compounds (EOX), of low-volatility halogenated hydrocarbons (SHKW), of highly volatile halogenated hydrocarbons (LHKW), of bound nitrogen, of cyanide, of sulphur, of phosphorus, of arsenic, of antimony, of mercury, of phenols and of other volatile organic compounds.
